(19) United States
(12) Patent Application Publication
(10) Pub. No.: US 2017/0305537 A1
(43) Pub. Date: Oct. 26, 2017

(54) UN-MANNED AERIAL VEHICLE

(71) Applicants: Pride Haley Smith, St. George, UT (US); David Alma Lynn Lewis, St. George, UT (US); Ryan Robert Walz, American Fork, UT (US)

(72) Inventors: Pride Haley Smith, St. George, UT (US); David Alma Lynn Lewis, St. George, UT (US); Ryan Robert Walz, American Fork, UT (US)

(73) Assignee: Tenshi Technologies, LLC (A Utah, LLC), American Fork, UT (US)

(21) Appl. No.: 15/133,444

(22) Filed: Apr. 20, 2016

(51) Int. Cl. B64C 27/02; G05D 1/10; B64D 47/02

(52) U.S. Cl. CPC B64C 27/02; G05D 1/104; G05D 1/101; B64D 47/02; B64C 2201/143; B64C 2201/12; B64C 2201/024

(57) ABSTRACT

An un-manned aerial vehicle including a powered chassis having a top side and a bottom side. The powered chassis includes a fuel powered electricity generator. The vehicle includes a flight system functionally coupled to the powered chassis. The vehicle includes a flood light system functionally coupled to a bottom side of the powered chassis and oriented to project light downward therefrom. The flood light system includes a plurality of modular lights that are able to selectably couple to the bottom side of the powered chassis. The flood light system includes a programmable light control module that controls lighting. The vehicle includes an automated flight control system functionally coupled to the flight system that automatically directs light from the flood light system to a desired region.

### BACKGROUND OF THE INVENTION

### Field of the Invention

The present invention relates to an un-manned aerial vehicle, specifically to lighted un-manned aerial vehicles.

### Description of the Related Art

An unmanned aerial vehicle (UAV), commonly known as a drone, as an unmanned aircraft system (UAS), and also referred by several other names, is an aircraft without a human pilot aboard. The flight of UAVs may be controlled with various kinds of autonomy : either by a given degree of remote control from an operator, located on the ground or in another vehicle, or fully autonomously, by onboard computers.

UAVs are often preferred for missions that are too “dull, dirty or dangerous” for manned aircraft. They have and are mostly found in military and special operation applications. Though, UAVs are increasingly finding uses in civil and recreational applications, such as policing and surveillance, aerial filming, and drone racing.

There are several names in use for unmanned aerial vehicles, which generally refer to the same concept. The term drone, more widely used by the public, was coined in reference to the resemblance of dumb-looking navigation and loud-and-regular motor sounds of old military unmanned aircraft to the male bee. The term has seen strong opposition from aviation professionals and government regulators.

Some improvements have been made in the field. Examples of references related to the present invention are described below in their own words, and the supporting teachings of each reference are incorporated by reference herein:

U.S. Pat. No. 8,970,400, issued to Verna et al., discloses a mass notification push application and a civic-communication application combined into one with the primary purpose of allowing up-to-the-minute UAV aerial imagery as selected by drone ground-based commanders to be automatically transmitted to subscribed end-users via the current OS mobile operating systems for smartphones, iPads, laptops, and web-enabled devices in a manner comprised of separate technologies such as voice (voice to text, voice recognition), video stills (embedded with personalized iconographic identifiers), and with a secondary purpose of allowing the notified recipients to engage others by allowing the retransmitting of received messages along with (or without) registered user annotations so as to create a civil communications hub for wider, real-time dissemination of ongoing situational awareness data.

U.S. Patent Application Publication No.: 2010/0161155, by Simeray, discloses an autonomous helicopter for recreational purposes or for a swarm-type surveillance system, characterized in that the helicopter has a complete automatic flight control, and in that the flight thereof is stable and automatic due to a device for the automatic control of the altitude, comprising at least two optical receivers, at least one optical emitter, at least two channels for processing signals of the receivers, and at least two motors controlling at least two propellers, at a speed proportional to the total amount of signals received. Said helicopter avoids obstacles by means of an orientation device controlled by the difference between the signals of the two receivers. It advances at a regular speed by means of a shift of the centre of gravity thereof in front of the axis of the two lifting propellers.

U.S. Patent Application Publication No.: 2016/0018822, by Nevdahs et al., discloses a method for an autonomous vehicle to follow a target is provided. The method may include obtaining a position and a velocity of a target and obtaining a position of an autonomous vehicle. The method may also include obtaining a path that encloses the position of the target and determining a path rate for the autonomous vehicle to move along the path based on the velocity of the target. The method may also include determining a path position along the path based on the position of the autonomous vehicle and determining a change in the position of the autonomous vehicle based on the path position, the path rate, and the velocity of the target. The method may also include adjusting a velocity and a direction of the autonomous vehicle to achieve the change in the position of the autonomous vehicle.

U.S. Patent Application Publication No.: 2015/0266577, by Jones et al., discloses various exemplary embodiments relate to a drone. The drone may include: a navigation unit configured to determine the location of the drone and navigate the drone to designated locations; a radio frequency identification (RFID) reader configured to read RFID tag information from RFID tags; and a wireless network transceiver configured to periodically transmit the location of the drone and RFID tag information to an inventory management system. Various exemplary embodiments relate to a method performed by a drone. The method may include: receiving navigation path information; navigating the drone along the navigation path based on satellite location signals; determining current position information based on the satellite location signals; reading RFID tag information from a first RFID tag; and transmitting the RFID tag information and the current position information via a wireless client to a central computing system.

The inventions heretofore known suffer from a number of disadvantages which include being limited in use, being limited in application, being expensive, being complex, being more convenient, being limited in modification, being non-industrious, being non-programmable, being not compact, being limited in lighting, being difficult to use, not having a broad range of use, not being suitable for industrial purposes, being limited to recreational uses, being limited to industrial/military uses, being complex to operate, failing to provide for lighting needs, being bulky, making it difficult to adjust lighting conditions, providing obstructed lighting, and the like and combinations thereof.

What is needed is an un-manned aerial vehicle, attachment and/or system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available un-manned aerial vehicle. Accordingly, the present invention has been developed to provide an un-manned aerial vehicle to provide lighting.

According to one embodiment of the invention, there is an un-manned aerial vehicle that may include a powered chassis that may have a top side and a bottom side. The powered chassis may include a fuel powered electricity generator. The vehicle may include a flight system that may be functionally coupled to the powered chassis. The flight system may be collapsible.

The vehicle may include a flood light system that may be functionally coupled to a bottom side of the powered chassis and may be oriented to project light downward therefrom. The flood light system may include a plurality of modular lights that may be able to selectably couple to the bottom side of the powered chassis. The flood light system may include a programmable light control module that may control lighting.

The vehicle may include an automated flight control system that may be functionally coupled to the flight system that may automatically direct light from the flood light system to a desired region. The automated flight control system may include a tracking module that follows a mobile object. The automated flight control system may include a swarm module that may allow for singular control of a plurality of UAVs. The automated flight control system may include a collision detection module. The vehicle may include a plurality of retractable legs that may be functionally coupled to the powered chassis. The plurality of retractable legs may include a modular light mount.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of an un-manned aerial vehicle with a flood light system, according to one embodiment of the invention;

FIG. 2 is a bottom plan view of an un-manned aerial vehicle with a flood light system, according to one embodiment of the invention;

FIG. 3 is a bottom plan view of an un-manned aerial vehicle, according to one embodiment of the invention;

FIG. 4 is a partial bottom perspective view of a flood light system mount of an un-manned aerial vehicle, according to one embodiment of the invention;

FIG. 5 is a partial top perspective view of a powered chassis of an un-manned aerial vehicle, according to one embodiment of the invention;

FIG. 6 is a side elevational view of an un-manned aerial vehicle, according to one embodiment of the invention;

FIG. 7 is a front perspective view of an un-manned aerial vehicle in a collapsed mode, according to one embodiment of the invention;

FIG. 8 is a front elevational view of an un-manned aerial vehicle with a flood light system, according to one embodiment of the invention;

FIG. 9 is a front elevational view of an un-manned aerial vehicle with a flood light system, according to one embodiment of the invention;

FIG. 10 is a perspective view of an un-manned aerial vehicle with a flood light system, according to one embodiment of the invention;

FIG. 11 is a partial bottom perspective view of an un-manned aerial vehicle with a plurality of modular lights, according to one embodiment of the invention;

FIG. 12 is a partial exploded bottom perspective view of an un-manned aerial vehicle with a plurality of modular lights, according to one embodiment of the invention;

FIG. 13 is a bottom plan view of an un-manned aerial vehicle in a collapsed mode with a plurality of modular lights, according to one embodiment of the invention;

FIG. 14 is a perspective view of a modular light, according to one embodiment of the invention;

FIG. 15 is a bottom plan view of an un-manned aerial vehicle with a plurality of modular lights, according to one embodiment of the invention;

FIG. 16 is a front elevational view of an un-manned aerial vehicle with a flood light system, according to one embodiment of the invention;

FIG. 17 is a front elevational view of an un-manned aerial vehicle with a flood light system, according to one embodiment of the invention;

FIG. 18 is a rear elevational view of an un-manned aerial vehicle with a flood light system, according to one embodiment of the invention;

FIG. 19 is a perspective view of an un-manned aerial vehicle hovering over a hiker, according to one embodiment of the invention; and

FIG. 20 is a module diagram of an un-manned aerial vehicle, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Andriod, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

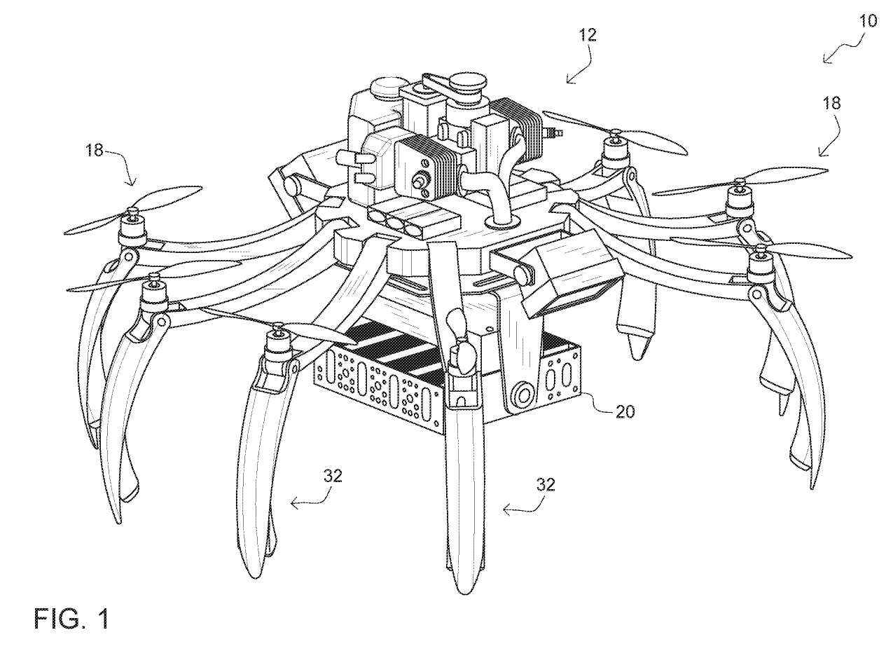

FIG. 1 is a perspective view of an un-manned aerial vehicle with a flood light system, according to one embodiment of the invention. There is shown an un-manned aerial vehicle 10 including a powered chassis 12, a flight system 18, and a downwardly directed flood light system 20 disposed at a bottom of the powered chassis.

The illustrated un-manned aerial vehicle 10 includes a powered chassis 12 having a fuel powered electricity generator connected thereto. The illustrated powered chassis includes a fuel-powered motor (e.g. gas, diesel, hydrogen fuel cell) for generating electricity to achieve long flight times and higher wattage output. The vehicle 10 includes a flight system 18 functionally coupled to the powered chassis 12. The powered chassis 12 provides power and a support frame for the vehicle and the internal and external modules and components coupled thereto. The powered chassis 12 also may include an engine, a transmission, drive shaft, differential, actuators, motors, engines, servos, batteries, capacitors, power distribution systems, fuel containers, fuel, fuel distribution systems, and/or suspension and/or other vehicle components/systems configured to support operation of the vehicle. The powered chassis 12 provides structure and power to the flight system 18.

The illustrated flight system 18 includes a plurality of propulsion devices (e.g. the illustrated propellers). Such propulsion devices are positioned on the vehicle in a manner that allows the same to lift the vehicle in the air and fly the same (e.g. the illustrated propellers disposed on outwardly extending legs 32 of the vehicle positioned and configured to lift the vehicle up into the air and perform aerial maneuvers during the operation thereof). The flight system may also include a control module and/or electronics/circuitry configured to control and/or operates the flight system in a desired manner Such may automatically and/or selectably alter one or more operational characteristics of one or more of the propulsion devices (e.g. rotational speed, orientation, position, blade inclination, fuel use rate, power allocated to the device). The flight system may include programming and/or other structures/devices for enhancing stability of the vehicle during operation, such as but not limited to a gyroscope, an accelerometer, compass, altimeter, GPS module, payload measurement systems, cameras, object recognition software, radar, thermometer, auto-leveling programming, auto-hover capabilities, obstacle avoidance programming and the like and combinations thereof. The illustrated un-manned aerial vehicle 10 may also include an automated flight control system functionally coupled to the flight system 18 that automatically directs light from the flood light system 20 to a desired region (e.g. by flying to a region that is over the region desired to be lighted while carrying a downwardly projecting flood light system as payload). The automated flight control system includes a tracking module, a swarm module, and a collision detection module. The automated flight system may include information about the geometries of the flood light system and/or in particular the shape and direction of a cone of light emitted thereby such that the automated flight system can be instructed (e.g. by remote control, programming/scripting, laser target identification, object recognition) to direct light at a particular region or at a particular object and the automated flight system is then able to calculate one or more flight positions/trajectories that will satisfy the lighting instructions.

Such may be accomplished by mathematically mapping backwards (e.g. if the flood light system projects light forward and downward at an angle of declination of 45 degrees lighting a circular area of a 3 meter radius at 5 meters away, the system may map backwards from the target using inverted specifications to find positions and orientations that the vehicle can occupy that will light the target region which would likely include positions 5 meters plus or minus an error factor related to the beam characteristics away at a 45 degree angle plus or minus an error factor related to the beam characteristics (e.g. the 3 meter beam radius at 5 meters) with the “front” of the vehicle oriented towards the target) from the target to be lighted to generate a region (e.g. a torus of possible positions for forward-downward directed flood light systems, a cylinder of possible positions for downward directed flood light systems) and then subtract portions of that region based on one or more programmed rules (e g minimize distance from operator, avoid obstacles, keep a minimum/maximum height from the ground, coordination with other vehicles) and then hover and/or fly in a path that includes the calculated position(s). The flight system may include one or more modules to perform one or more of the functions described herein, including but not limited to modules that acquire flood light beam characteristic information from a flood light system/attachment, receive target lighting instructions, calculate flight positions/paths to achieve target lighting objectives, virtual region generation, map generation, proprioception detection/tracking, manage/enforce/generate flight rules, lighting controls (e.g. on/off, intensity, direction, orientation, mode selection, system selection).

The following are non-limiting examples of drone flight control systems and/or components of the same: Navio autopilot by Emlid Limited of Hong Kong, Dragon Link V3 Advance System by FPV Pro of Miami Florida, Spektrum Aircraft Telemetry GPS Sensor by Horizon Hobby, Inc. of Champaign Ill., 3D Robotics APM MinimOSD Rev. 1.1 Kit by 3DR of Berkely Calif., Radiolink OSD Telemetry Module by Radiolink Electronics Limited of Shenzen Guangdong China, XPAD2 30 km Long Range Video and Telemetry Kit by Digital Micro Devices of Museros Spain, Pixhawk Autopilot Software and/or hardware systems by the independent open-hardware project entitled Pixhawk that can be found at pixhawk.org, DJI Wookong-M flight Control System by DJI of Nanshan District Shenzhen China, ArduPilot Autopilot Suite and/or Mega UAV Controller by ArduPilot an open-source community found at copter.ardupilot.org, Spektrum Dx6i 6Ch Dsmx Radio System with Ar610 Receiver by Horizon Hobby, Inc. of Champaign Ill., and the like and combinations thereof. Flight automation may include one or more of the following non-limiting features/capabilities: follow feature, tag to target, light GPS coordinates, scripted lighting path, automatically light areas needed (e.g. the area ahead of a walker, on an emergency victim, different areas on a music video shoot based on music played).

The illustrated un-manned aerial vehicle 10 includes a flood light system 20 functionally coupled to a bottom side of the powered chassis 12 oriented to project light downward therefrom. In an alternative variation, the flood light is mounted to the powered chassis using a boom, arm, flexible mount, flex-conduit or the like or combinations thereof. Such may be mounted to a position on the powered chassis other than the bottom thereof but still direct light downwardly therefrom. The flood light system may include a plurality of modular lights that are selectably coupled to the bottom side of the powered chassis 12. The lights may be broad-beamed, high-intensity lights that may include one or more light reflector/focus structures configured to direct light produced therein into a directional beam. A reflector may include a concave body having a reflective inner surface that is disposed adjacent to and/or around the light generating device (e.g. LED, fluorescent bulbs, powered filament/incandescent, high Intensity Discharge lamps e.g. metal-halide, Low pressure Sodium lamps e.g. sodium-vapor lamps, halogen lamps) such that light produced thereby is redirected to a general direction instead of being free to illuminate in all directions. This focuses the light and directs it towards a particular region. Generally the lamp projects through a center of the concave reflector so that light is projected “forward” in a symmetrical pattern. The light system may draw power from the powered chassis and/or may receive operational instructions from the flight system. The flood light system may include one or more servos, motors, controllers, actuators and the like that may direct, orient, position and/or otherwise alter one or more operational characteristics (e.g. intensity, light path, focus, color, on/off, strobe) of the flood lighting of the flood light system.

The illustrated un-manned aerial vehicle 10 includes a plurality of retractable legs 32 functionally coupled to the powered chassis 12. The plurality of retractable legs 32 are designed to provide landing support to the vehicle 10 during take-off and landing. The retractable legs may be manually operated and/or may include actuators, locks, and/or control module(s) that permit remote and/or automatic operation thereof (e.g. retraction and/or extension).

According to one embodiment of the invention, there is a drone or an un-manned aerial vehicle designed to assist individuals on the ground with aerial lighting from above. The lighting may be on a gimbal system and/or may be built directly into the drone. A gimbal is a pivoted support that allows the rotation of an object about a single axis. A set of three gimbals, one mounted on the other with orthogonal pivot axes, may be used to allow an object mounted on the innermost gimbal to remain independent of the rotation of its support. For example, on a ship, the gyroscopes, shipboard compasses, stoves, and even drink holders typically use gimbals to keep them upright with respect to the horizon despite the ship's pitching and rolling. Gimbals may be used in situations like: construction, safety, search and rescue, event lighting, film lighting, etc. A gimbal may include one or more modular mounts for lighting so lighting may be swapped out. There may be a version that may include a gas powered motor to generate power to give longer flight time and a higher watt output. It may have universal mounting for industrial lighting. It may also include an onboard SOS signal over radio signals.

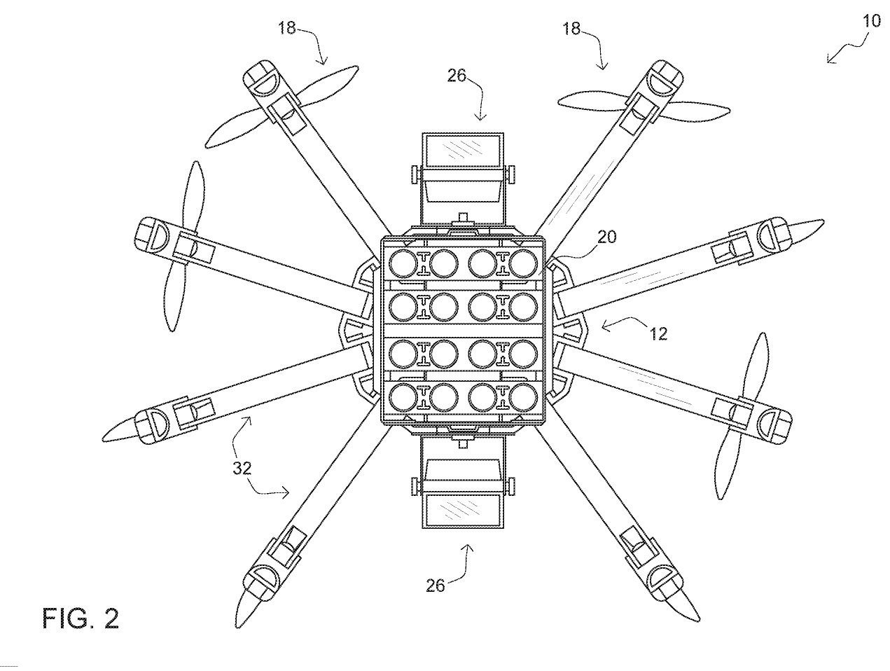

FIG. 2 is a bottom plan view of an un-manned aerial vehicle with a flood light system, according to one embodiment of the invention. There is shown an un-manned aerial vehicle 10 including a powered chassis 12 coupled to a flight system 18, a flood light system 20, and a plurality of retractable legs 32.

The illustrated un-manned aerial vehicle 10 includes a powered chassis 12 having a fuel powered electricity generator connected thereto. The vehicle 10 includes a flight system 18 functionally coupled to the powered chassis 12. The powered chassis 12 is designed to provide a support frame for the vehicle and the internal and external modules and components coupled thereto. The powered chassis 12 is designed to provide power to the flight system 18. The illustrated flight system 18 includes a plurality of propellers designed to lift the vehicle up into the air and perform aerial maneuvers.

The illustrated un-manned aerial vehicle 10 includes a flood light system 20 including an array of flood lights within a housing that is functionally coupled to a bottom side of the powered chassis 12 oriented to project light downward therefrom. The flood light system may also include a plurality of modular flood lights 26 that are selectably coupled to side/front mounts of the powered chassis 12. A flood light system may include one or more of the following: flood lighting, downward facing lighting, film lighting, spot lighting, directional lighting, colored lighting, construction lighting, high-output flood and spotlighting, safety lighting, flashing lights, multi-colored LED lighting, event lighting, lasers, disco-balls, search and rescue lighting, black-lighting, concert lighting, military lighting, convoy lighting, flanking lighting, scouting lighting, similar such lighting and/or combinations thereof.

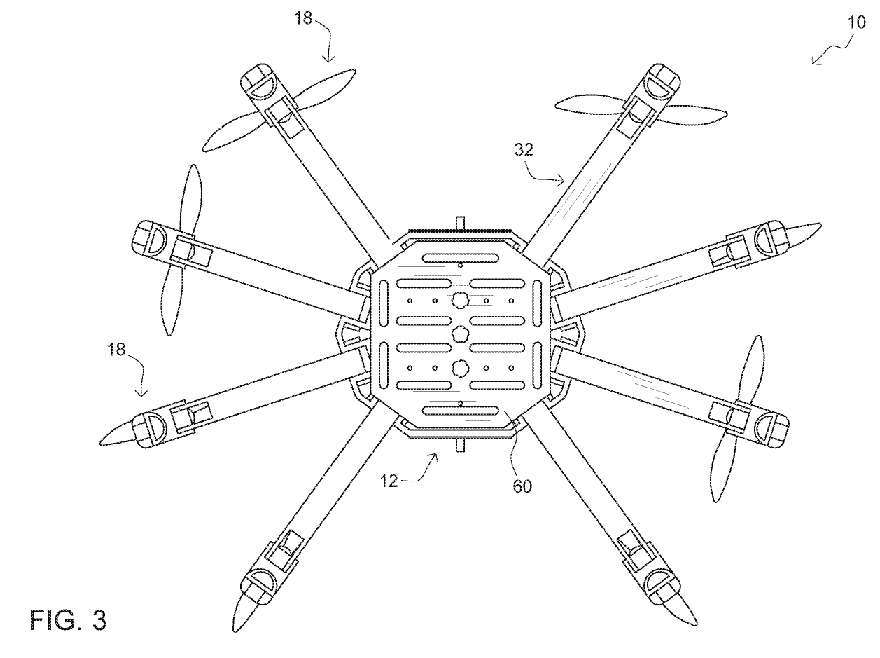

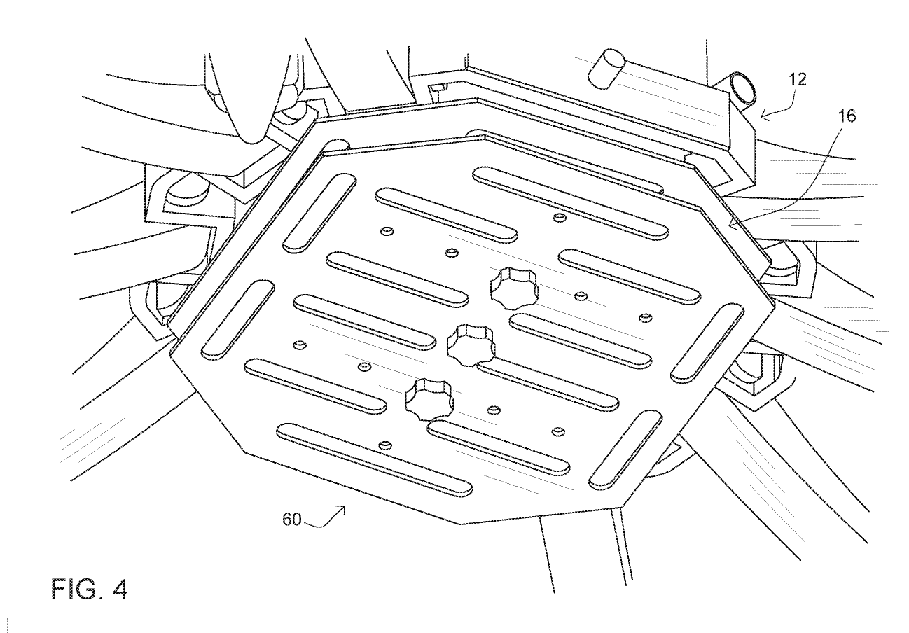

FIGS. 3 and 4 illustrate a bottom plan view and a bottom perspective view of an un-manned aerial vehicle with a flood light system mount, according to one embodiment of the invention. There is shown an un-manned aerial vehicle 10 including a powered chassis 12 functionally coupled to a flight system 18, a plurality of retractable legs 32 and a flood light system mount 60 to which a flood light system may be coupled.

The illustrated un-manned aerial vehicle 10 includes a powered chassis 12 for supporting the internal and external modules and components of the vehicle 10. The vehicle 10 includes a flight system 18 functionally coupled to the powered chassis 12. The powered chassis 12 also may include an engine, a transmission, drive shaft, differential, and/or suspension. The powered chassis 12 is designed to provide power to the flight system 18. The illustrated flight system 18 includes a plurality of propellers designed to lift the vehicle 10 up into the air and perform aerial maneuvers. As illustrated, the flight system 18 includes a total of eight propellers disposed above eight retractable legs 32; wherein the eight propellers work in unison to maneuver the vehicle 10 through the air.

The illustrated un-manned aerial vehicle 10 includes a flood light system functionally coupled to a bottom side 16 of the powered chassis 12 oriented to project light downward therefrom. The vehicle 10 includes a flood light system mount 60 designed to functionally couple to a flood light system and/or a gimbal system or the like to support and operate a flood light system. The mount 60 includes a support plate spaced apart from the body of the vehicle and includes a plurality of apertures and slots through which mounting devices (e.g. screws, bolts, rivets, clips, snaps, toggles) may be disposed to couple thereto. The illustrated plurality of retractable legs 32 are functionally coupled to the powered chassis 12. The plurality of retractable legs 32 are designed to provide landing support to the vehicle 10 during take-off and landing.

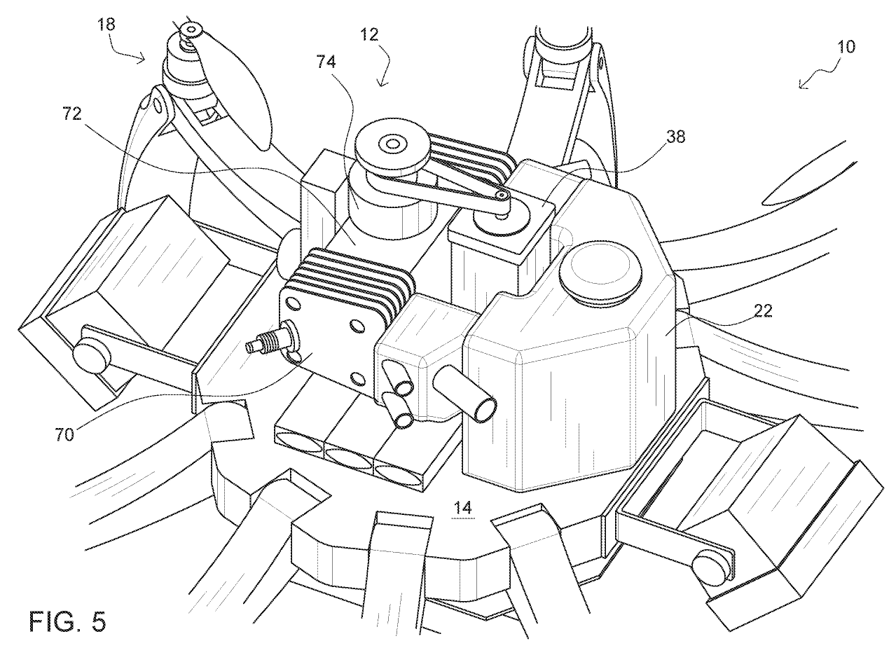

FIG. 5 is a top perspective view of a powered chassis, according to one embodiment of the invention. There is shown a powered chassis 12 of an un-manned aerial vehicle.

The illustrated powered chassis 12 includes a fuel powered electricity generator 38 connected thereto. The fuel powered electricity generator 38, which may be a battery pack, is designed to provide a power source to the modules and components of an un-manned aerial vehicle. The powered chassis 12 is designed to provide a support frame for the vehicle and the internal and external modules and components coupled thereto. The powered chassis 12 includes an engine 70, a transmission 72, a drive shaft 74, a differential a coupled to a top side 14 of the powered chassis 12. A fuel supply is disposed within a fuel tank 22 functionally coupled to the engine 70. The powered chassis 12 is designed to provide power to a flight system 18. The flight system 18 includes a plurality of propellers designed to lift the vehicle up into the air and perform aerial maneuvers.

The illustrated un-manned aerial vehicle 10 includes an automated flight control system functionally coupled to the flight system 18 that automatically directs light from a flood light system to a desired region. The automated flight control system includes a tracking module, a swarm module, and a collision detection module.

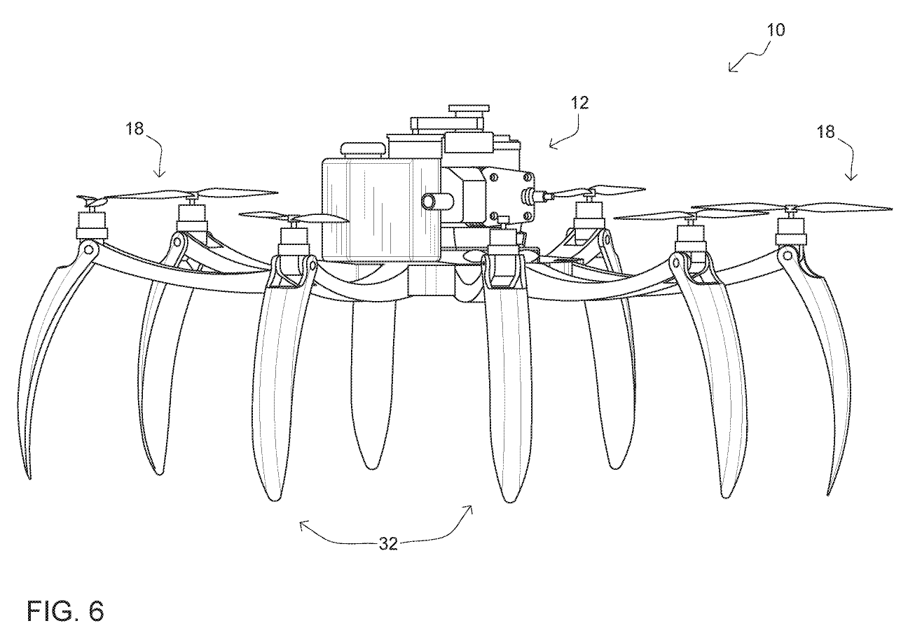

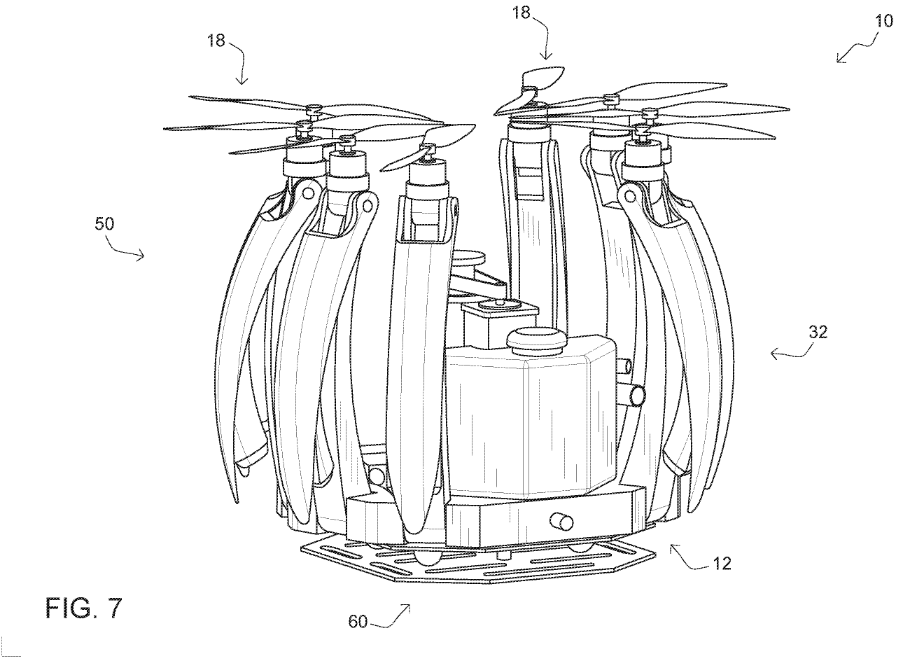

FIGS. 6 and 7 illustrate a side elevational view and a front perspective view of an un-manned aerial vehicle, according to one embodiment of the invention. There is shown an un-manned aerial vehicle 10 including a powered chassis 12, a flight system 18, a plurality of retractable legs 32, and a flood light system mount 60.

The illustrated un-manned aerial vehicle 10 includes a powered chassis 12 designed to provide a support frame for the vehicle and the internal and external modules and components coupled thereto. The powered chassis 12 is designed to provide power to a flight system 18. The illustrated flight system 18 includes a plurality of propellers designed to lift the vehicle up into the air and perform aerial maneuvers.

The illustrated un-manned aerial vehicle 10 includes a plurality of retractable legs 32 functionally coupled to the powered chassis 12. The plurality of retractable legs 32 are designed to provide landing support to the vehicle 10 during take-off and landing. The illustrated un-manned aerial vehicle 10 includes an automated flight control system functionally coupled to the flight system 18 that automatically directs light from the flood light system to a desired region. The automated flight control system includes a tracking module, a swarm module, and a collision detection module. The un-manned aerial vehicle 10 includes a flood light system mount 60 designed to functionally couple to a gimbal system or the like to support and operate a flood light system. As illustrated in FIG. 7, the flight system 18 is collapsible 50 and the legs 32 are retractable.

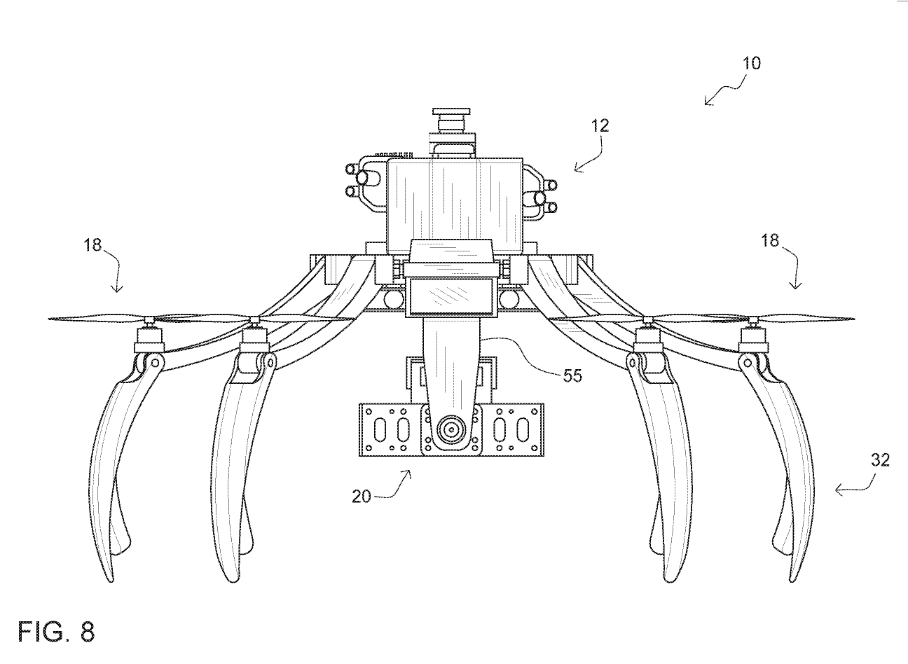

FIGS. 8-10 illustrate a plurality of side elevational views of an un-manned aerial vehicle with a flood light system, according to one embodiment of the invention. There is shown an un-manned aerial vehicle 10 including a powered chassis 12, a flight system 18, a plurality of retractable legs 32, and a flood light system 20.

The illustrated un-manned aerial vehicle 10 includes a powered chassis 12 designed to provide a support frame for the vehicle and the internal and external modules and components coupled thereto. The vehicle 10 includes a flight system 18 functionally coupled to the powered chassis 12. The powered chassis 12 is designed to provide power to the flight system 18. The illustrated flight system 18 includes a plurality of propellers designed to lift the vehicle up into the air and perform aerial maneuvers.

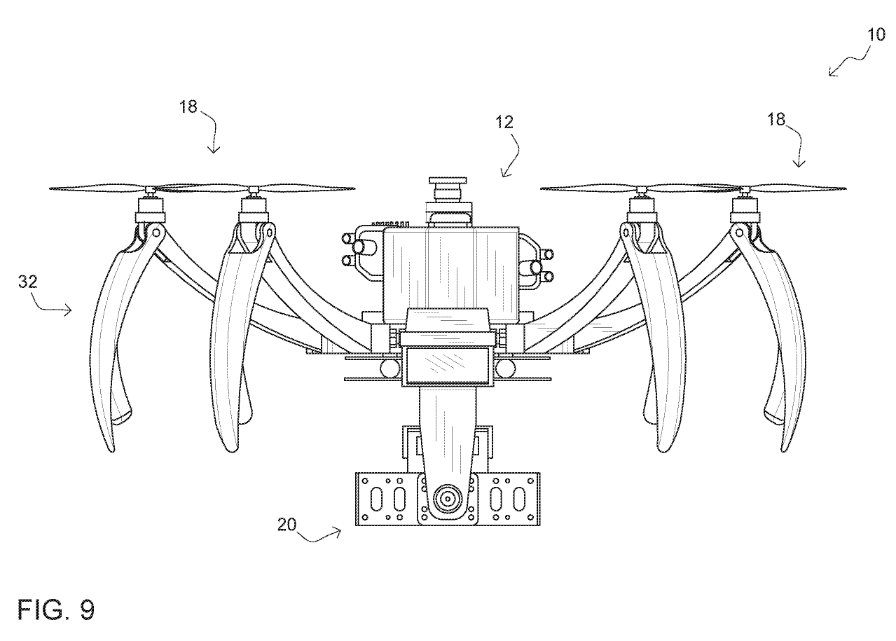

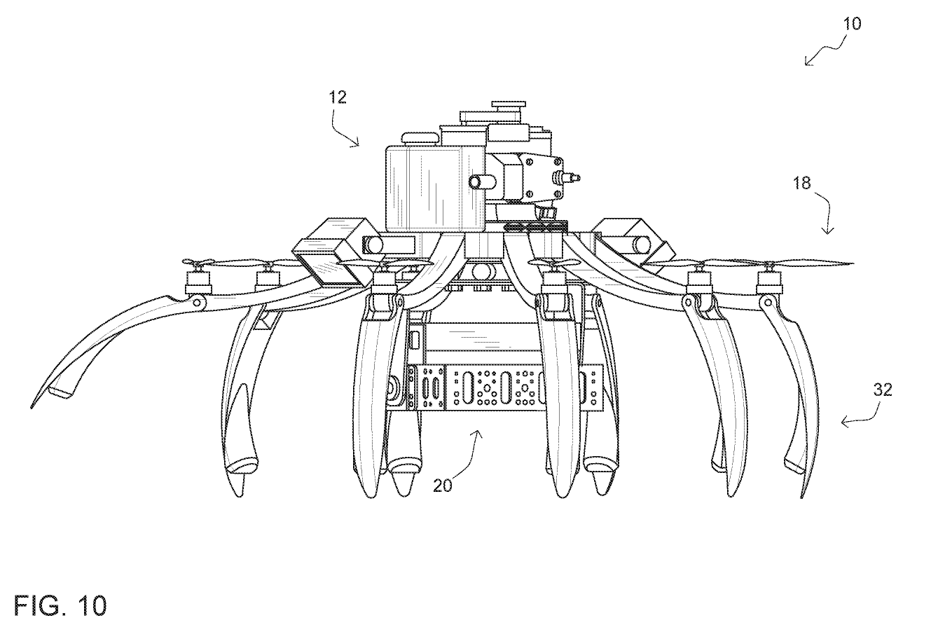

The illustrated un-manned aerial vehicle 10 includes a flood light system 20 functionally coupled to a bottom side of the powered chassis 12 oriented to project light downward therefrom. The illustrated un-manned aerial vehicle 10 includes a plurality of retractable legs 32 functionally coupled to the powered chassis 12. The plurality of retractable legs 32 are designed to provide landing support to the vehicle 10 during take-off and landing. The flood light system 20 is designed to functionally couple to a gimbal system 55, as shown in FIG. 8 or the like to support and operate the flood light system 20. Also shown in FIG. 8 is a configuration for the retractable legs 32 to land the un-manned aerial vehicle. Shown in FIGS. 9 and 10, the retractable legs 32 are in configuration for flight or aerial maneuvering.

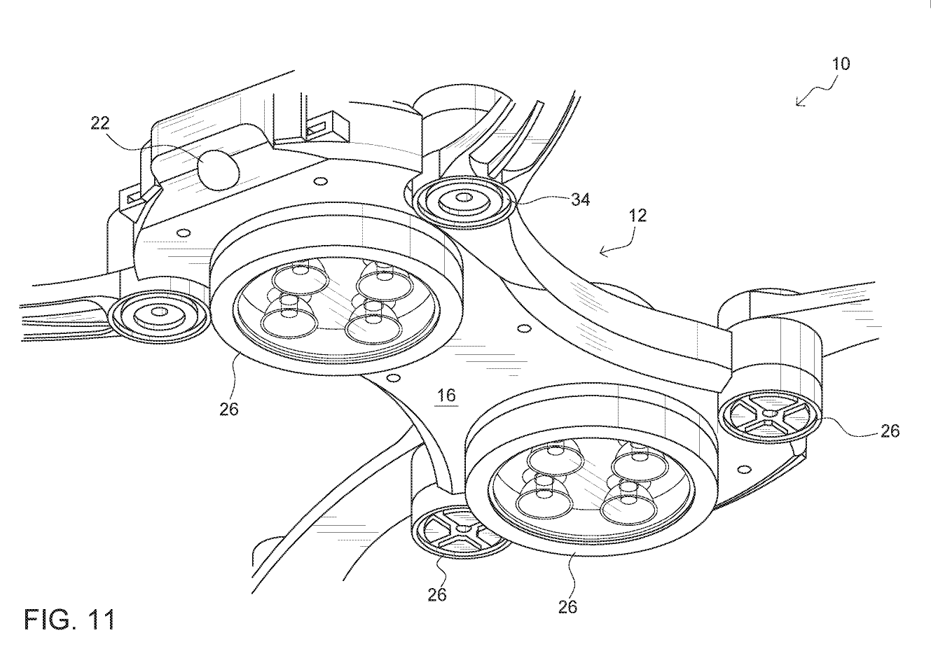

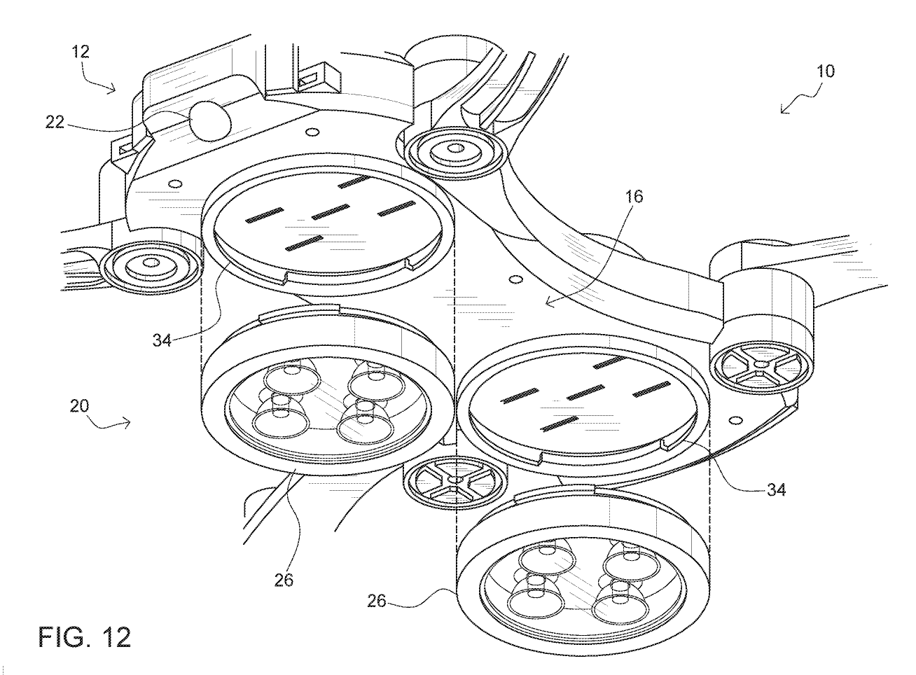

FIGS. 11-13 illustrate a plurality of views of an un-manned aerial vehicle with a plurality of modular lights, according to one embodiment of the invention. There is shown an un-manned aerial vehicle 10 including a powered chassis 12, a flood light system 20, a plurality of modular lights 26, a plurality of module light mounts 34, and an automated flight control system 22.

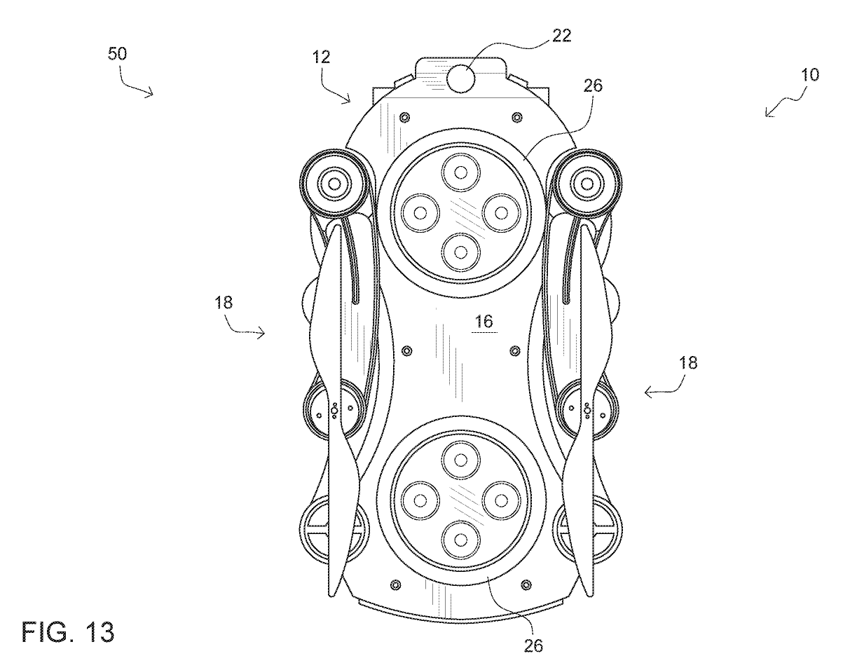

The illustrated un-manned aerial vehicle 10 includes a powered chassis 12 designed to provide a support frame to the internal and external modules and components of the vehicle 10. The vehicle 10 includes a flight system 18 functionally coupled to the powered chassis 12. The powered chassis 12 is designed to provide power to the flight system 18. The illustrated flight system 18 includes a plurality of propellers designed to lift the vehicle up into the air and perform aerial maneuvers. As illustrated in FIG. 13, the flight system 18 is collapsible 50.

The illustrated un-manned aerial vehicle 10 includes a flood light system 20 functionally coupled to a bottom side 16 of the powered chassis 12 oriented to project light downward therefrom. The flood light system 20 includes a plurality of modular lights 26 that are selectably coupled to the bottom side 16 of the powered chassis 12.

The illustrated un-manned aerial vehicle 10 includes a plurality of retractable legs 32 functionally coupled to the powered chassis 12. The plurality of retractable legs 32 are designed to provide landing support to the vehicle 10 during take-off and landing. In addition, as illustrated in FIG. 13, the legs 32 are retractable. The plurality of retractable legs 32 includes a plurality of modular light mounts 34 coupled to a bottom side of the retractable legs. As illustrated the modular light mount 34 may also be coupled to the bottom side 16 of the powered chassis 12 to provide improved lighting underneath the vehicle 10.

The illustrated un-manned aerial vehicle 10 includes an automated flight control system 22 functionally coupled to the flight system 18 that automatically directs light from the flood light system 20 to a desired region. The automated flight control system 22 includes a tracking module, a swarm module, and a collision detection module.

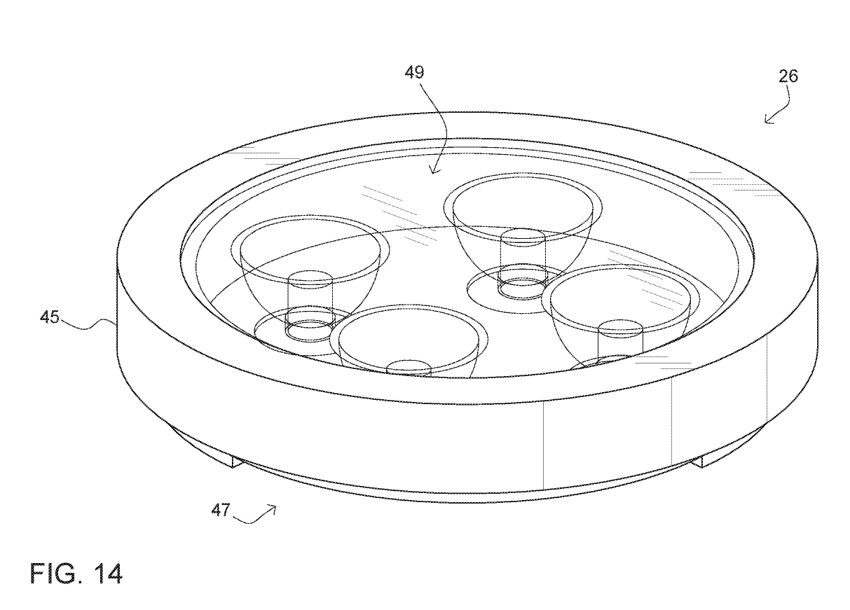

FIG. 14 is a perspective view of a modular light, according to one embodiment of the invention. There is shown a modular light 26 including a casing 45, an attachment member 47, and a plurality of lights 49.

The illustrated modular light 26 is part of a flood light system functionally coupled to an un-manned aerial vehicle. The modular light 26 is designed to project light downwardly from the vehicle. The modular light 26 includes a casing 45 designed to support the modules and components of the light 26. The modular light 26 includes an attachment member 47 designed to couple to a modular light mount. The modular light 26 includes a plurality of lights 49 disposed within the casing 45. The modular light may include one of the following: flood lighting, downward facing lighting, film lighting, spot lighting, directional lighting, colored lighting, construction lighting, high-output flood and spotlighting, safety lighting, flashing lights, multi-colored LED lighting, event lighting, lasers, disco-balls, search and rescue lighting, black-lighting, concert lighting, military lighting, convoy lighting, flanking lighting, scouting lighting.

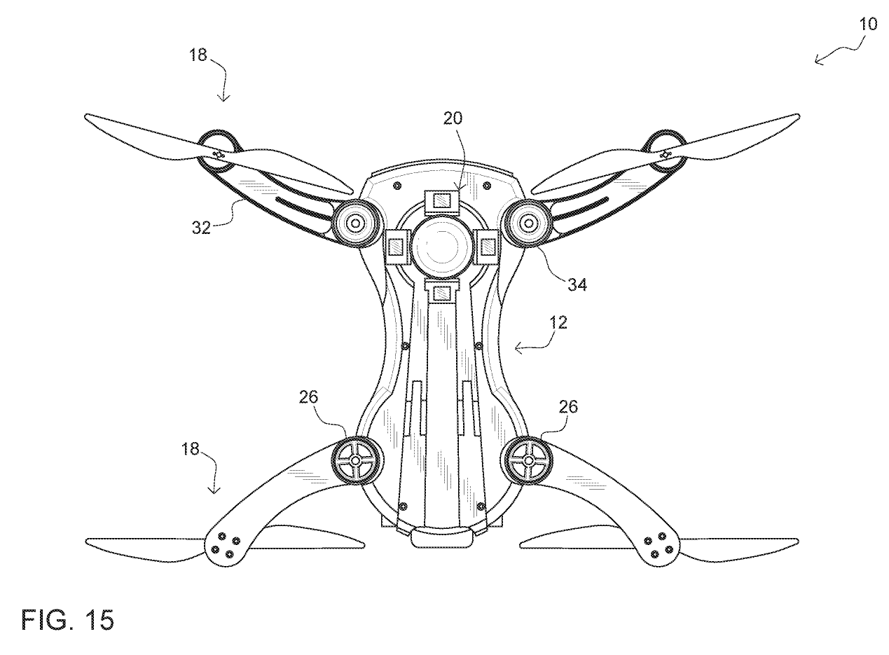

FIG. 15 is a bottom plan view of an un-manned aerial vehicle with a plurality of modular lights, according to one embodiment of the invention. There is shown an un-manned aerial vehicle 10 including a powered chassis 12, a flight system 18, a plurality of retractable legs 32, a plurality of modular lights, a plurality of modular light mounts, and a flood light system 20.

The illustrated un-manned aerial vehicle 10 includes a powered chassis 12 designed to provide a support frame for the vehicle and the internal and external modules and components coupled thereto. The vehicle 10 includes a flight system 18 functionally coupled to the powered chassis 12. The powered chassis 12 may include an engine, a transmission, drive shaft, differential, and/or suspension. The powered chassis 12 is designed to provide power to the flight system 18. The illustrated flight system 18 includes a plurality of propellers designed to lift the vehicle 10 up into the air and perform aerial maneuvers.

The illustrated un-manned aerial vehicle 10 includes a flood light system 20 functionally coupled to a bottom side of the powered chassis 12 oriented to project light downward therefrom. The flood light system 20 includes a plurality of modular lights 26 that are selectably coupled to the bottom side of the powered chassis 12.

The illustrated un-manned aerial vehicle 10 includes a plurality of retractable legs 32 functionally coupled to the powered chassis 12. The plurality of retractable legs 32 are designed to provide landing support to the vehicle 10 during take-off and landing. Each retractable leg 32 includes a modular light mount 34 designed to quickly and easily selectably couple to the modular light 26.

The illustrated un-manned aerial vehicle 10 includes an automated flight control system functionally coupled to the flight system 18 that automatically directs light from the flood light system 20 to a desired region. The automated flight control system includes a tracking module, a swarm module, and a collision detection module.

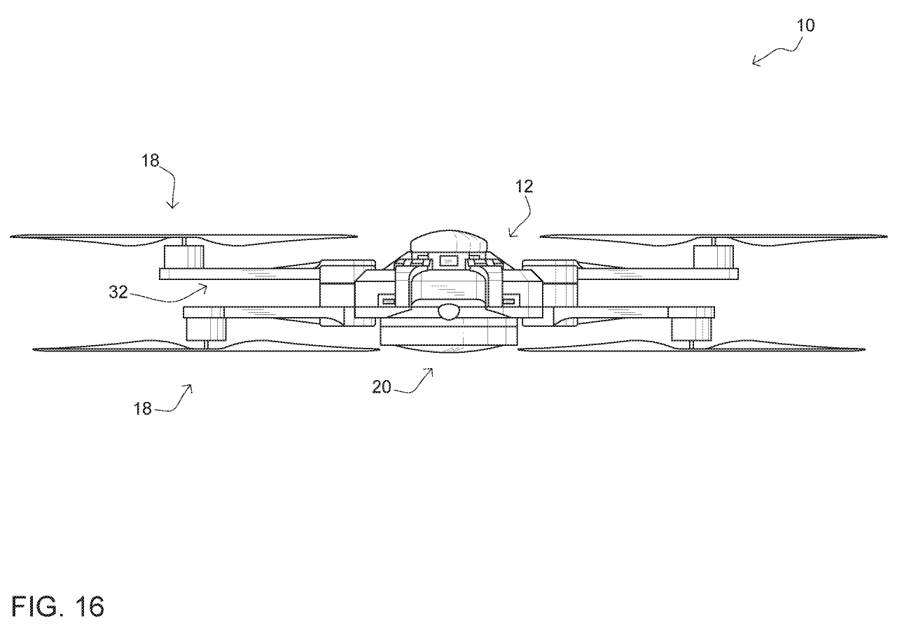

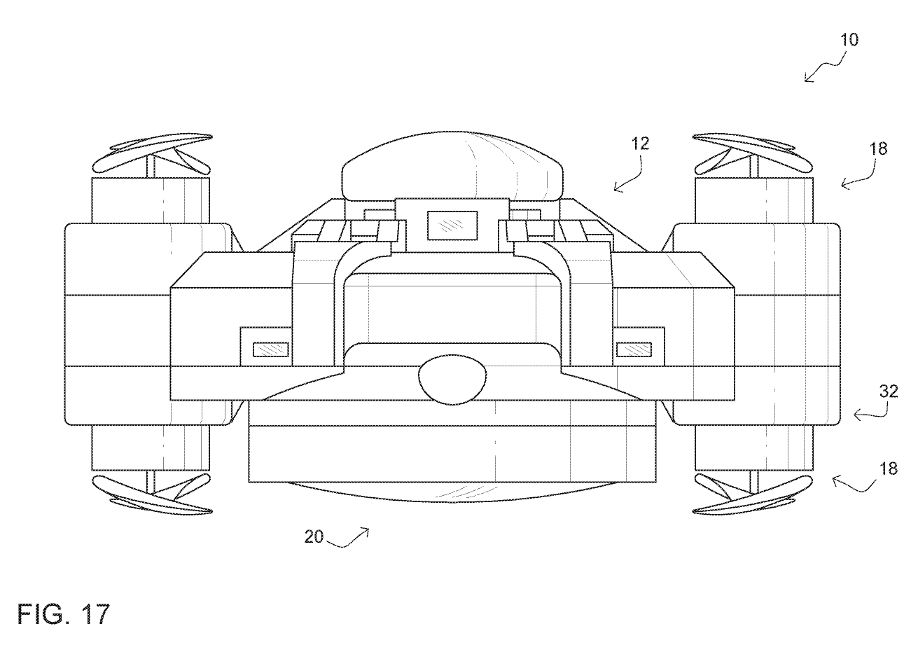

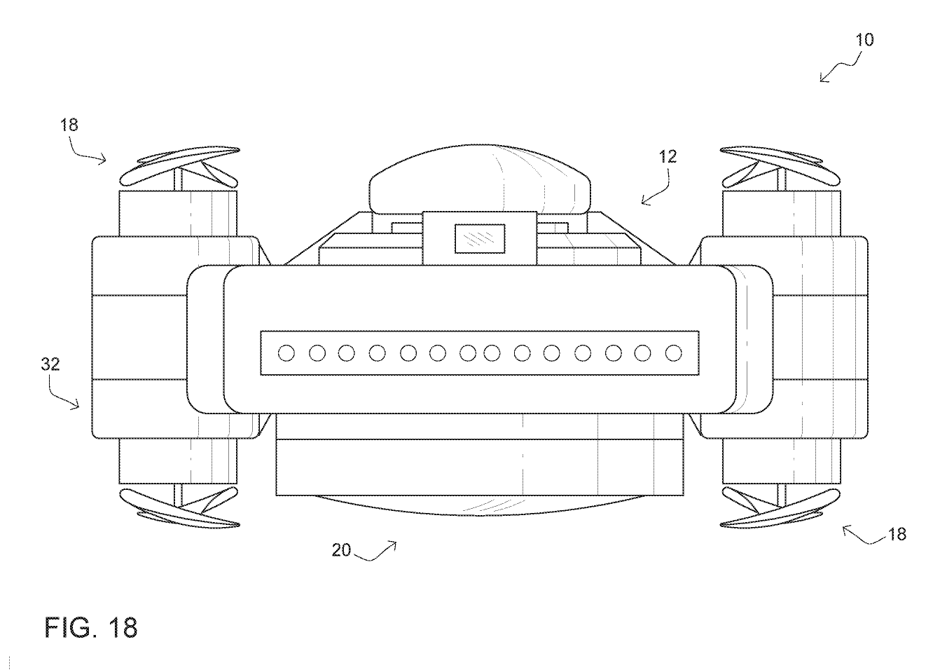

FIGS. 16-18 illustrate a plurality of side elevational views of an un-manned aerial vehicle with a flood light system, according to one embodiment of the invention. There is shown an un-manned aerial vehicle 10 including a powered chassis 12, a flight system 18, an automated flight control system, and a flood light system 20.

The illustrated un-manned aerial vehicle 10 includes a powered chassis 12 designed to provide a support frame for the vehicle and the internal and external modules and components coupled thereto. The vehicle 10 includes a flight system 18 functionally coupled to the powered chassis 12. The powered chassis 12 may include an engine, a transmission, drive shaft, differential, and/or suspension. The powered chassis 12 is designed to provide power to the flight system 18. The illustrated flight system 18 includes a plurality of propellers designed to lift the vehicle up into the air and perform aerial maneuvers.

The illustrated un-manned aerial vehicle 10 includes a flood light system 20 functionally coupled to a bottom side of the powered chassis 12 oriented to project light downward therefrom. The flood light system may include a plurality of modular lights that are selectably coupled to the bottom side of the powered chassis 12.

The illustrated un-manned aerial vehicle 10 includes a plurality of retractable legs 32 functionally coupled to the powered chassis 12. The plurality of retractable legs 32 are designed to provide landing support to the vehicle 10 during take-off and landing. The illustrated un-manned aerial vehicle 10 includes an automated flight control system functionally coupled to the flight system 18 that automatically directs light from the flood light system 20 to a desired region. The automated flight control system includes a tracking module, a swarm module, and a collision detection module.

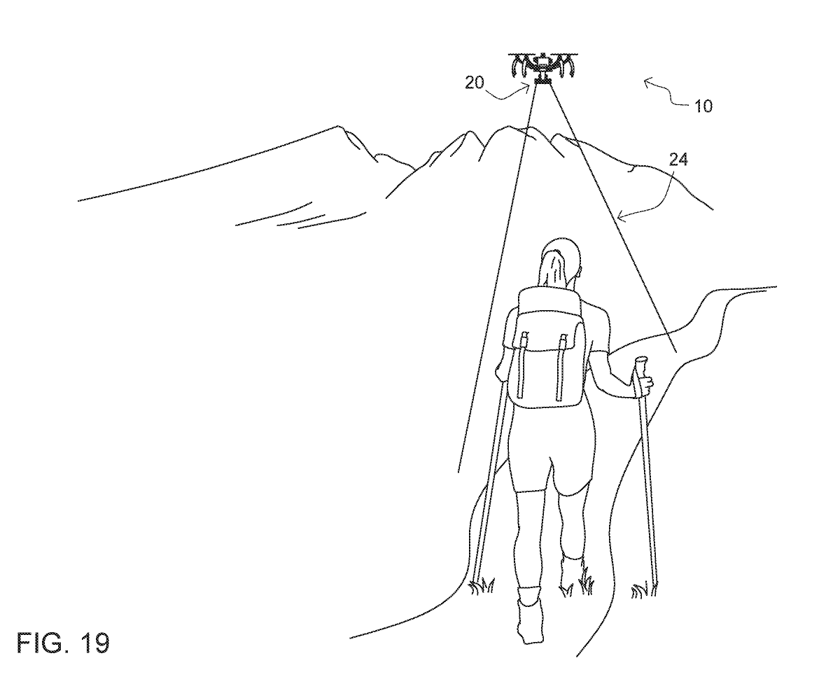

FIG. 19 is a perspective view of an un-manned aerial vehicle hovering over a hiker, according to one embodiment of the invention. There is shown an un-manned aerial vehicle 10 hovering over a hiker; wherein the vehicle 10 includes a flood light system 20. As used herein hiker may refer to any ground-based person/group and is not limited to recreational wilderness walkers.

In operation of an un-manned aerial vehicle 10, a hiker pre-sets commands or instructions to the vehicle 10; wherein the vehicle 10 is designed to hover over the hiker and illuminate a path of the hiker. As illustrated the un-manned aerial vehicle 10 includes a flood light system 20 functionally coupled to a bottom side of the vehicle 10 and oriented to project light downward therefrom to a desired region 24. The flight system may include one or more sensors, controls, modules, and the like for directing light in a region desired by the hiker. The following are non-limiting examples of how such systems may operate:

### PROPHETIC EXAMPLE 1

The drone detects the hiker (e.g. object recognition software/hardware, Bluetooth/RFID tracking), tracks the hiker's ongoing position and velocity and predicts the path the hiker is expected to take and then directs light ahead on that expected path.

### PROPHETIC EXAMPLE 2

The drone has a preprogrammed path and follows that path lighting the way for the hiker. The drone may detect the hiker and may stop/slow/pause/speed-up in its path progression to better match the position and velocity of the hiker.

### PROPHETIC EXAMPLE 3

The drone either has a preprogrammed flight path/region or flies in association with the hiker's movements but it is scanning (e.g. searching for IR signatures, object recognition) for particular objects/etc. and deviates from the flight path to illuminate such when found (e.g. search and rescue).

### PROPHETIC EXAMPLE 4

The drone has a preprogrammed flight path that is synchronized with another system (e.g. film schedule, music progression, live-action gaming system) and the “hiker” (e.g. performer, game player) is expected to keep up.

### PROPHETIC EXAMPLE 5

The drone hovers over a work area until signaled (e.g. audio signal from workers using voice recognition technology, laser pointer, remote control instruction signal) that work in that location is complete and then moves to hover over a next-scheduled work area (e.g. pre-scripted flight path data).

### PROPHETIC EXAMPLE 6

The drone detects and tracks the hiker and calculates a flight path/position to continuously illuminate the hiker and/or one or more regions around the hiker using a flood light system having multiple cones/zones/areas of illumination.

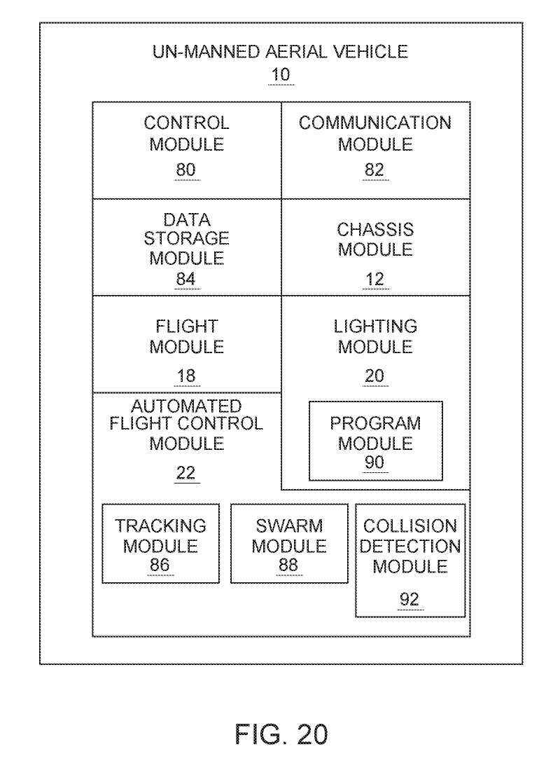

FIG. 20 is a module diagram of an un-manned aerial vehicle 10, according to one embodiment of the invention. There is shown an un-manned aerial vehicle 10 including a control module 80, a communication module 82, a data storage module 84, a powered chassis module 12, a flight system module 18, a lighting system module 20, an automated flight control module 22, a tracking module 86, a swarm module 88, a program module 90, and a collision detection module 92.

The illustrated un-manned aerial vehicle includes a control module 80 that provides operational instructions and commands to the modules and components of the vehicle 10. The control module 80 is in communication with the modules and components of the vehicle 10 (and/or other modules described herein) and provides managerial instructions and commands thereto. The source of such instructions/commands may be from one or more other modules described herein and/or through interactions between one or more other modules described herein. The control module 80 sets parameters and settings for each module and component of the vehicle 10. In addition, the control module 80 may include a processor for managing and processing data transferred through the vehicle 10. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated un-manned aerial vehicle 10 includes a communication module 82, such as a network card, system bus, or wireless communication module, and communicates with a computerized network. The communication module 82 provides communication capabilities, such as wireless communication, to the modules and components of the vehicle 10 and the components and other modules described herein. The communication module 82 provides communication between a wireless device, such as a mobile phone or remote computing device, and a computerized network and/or to facilitate communication between a mobile device and the vehicle 10 described herein. The communication module 82 may have a component thereof that is resident on a user's mobile device or on a user's desktop computer. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated un-manned aerial vehicle 10 includes a data storage module 84 in communication with the modules and components of the vehicle 10. The data storage module 84 stores data from each of the modules of the vehicle 10. The data storage module 84 is in communication with the various modules and components of the vehicle 10 and stores data transferred there through. The data storage module 84 stores data transferred through each of the modules of the vehicle 10, thereby updating the data storage module with up to date data and real time user and GPS data. The data storage module 84 securely stores location data and user data along with data transferred through the vehicle 10. Data storage modules may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated un-manned aerial vehicle 10 includes a chassis module 12 in communication with the modules and components of the vehicle 10. The chassis module 12 provides power to the vehicle 10. The chassis module 12 The illustrated un-manned aerial vehicle 10 includes a powered chassis 12 having a fuel powered electricity generator connected thereto. The vehicle 10 includes a flight system 18 functionally coupled to the powered chassis 12. The powered chassis 12 is designed to provide a support frame for the vehicle and the internal and external modules and components coupled thereto. The powered chassis 12 also may include an engine, a transmission, drive shaft, differential, and/or suspension. The powered chassis 12 is designed to provide power to the flight system 18.

The illustrated flight system 18 includes a plurality of propellers designed to lift the vehicle up into the air and perform aerial maneuvers.

The illustrated un-manned aerial vehicle 10 includes a flood light system 20 functionally coupled to a bottom side of the powered chassis 12 oriented to project light downward therefrom. The flood light system may include a plurality of modular lights that are selectably coupled to the bottom side of the powered chassis 12.

The illustrated un-manned aerial vehicle 10 includes a plurality of retractable legs 32 functionally coupled to the powered chassis 12. The plurality of retractable legs 32 are designed to provide landing support to the vehicle 10 during take-off and landing. The illustrated un-manned aerial vehicle 10 includes an automated flight control system functionally coupled to the flight system 18 that automatically directs light from the flood light system 20 to a desired region. The automated flight control system includes a tracking module, a swarm module, and a collision detection module. The tracking module may track one or more targets/objects using one or more sensors/cameras and object recognition software. The swarm module may coordinate position and velocity information, including flight path information with one or more other vehicles/systems and may receive instructions and/or automatically change flight characteristics/paths/patterns based on received information/instructions. The collision detection module may track one or more objects and/or environmental features (e.g. trees, cliffs, walls, ceilings, drones, people) and calculate projections of future position and/or path information to determine if there is a risk of collision. Such a system may issue flight instructions to one or more drones/systems/people to warn of the collision and/or to automatically cause a change in trajectory.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. An un-manned aerial vehicle, comprising:
a) a powered chassis having a top side and a bottom side;
b) a flight system functionally coupled to the powered chassis;
c) a flood light system functionally coupled to a bottom side of the powered chassis and oriented to project light downward therefrom; and
d) an automated flight control system functionally coupled to the flight system that automatically directs light from the flood light system to a desired region.

2. The vehicle of claim 1, wherein the flood light system includes a plurality of modular lights able to selectably couple to the bottom side of the powered chassis.

3. The vehicle of claim 1, wherein the automated flight control system includes a tracking module that follows a mobile object.

4. The vehicle of claim 1, wherein the automated flight control system includes a swarm module that allows for singular control of a plurality of UAVs.

5. The vehicle of claim 1, further comprising a plurality of retractable legs functionally coupled to the powered chassis.

6. The vehicle of claim 5, wherein the plurality of retractable legs include modular light mounts.

7. The vehicle of claim 1, wherein the flight system is collapsible.

8. The vehicle of claim 1, wherein the flood light system includes a programmable light control module that controls lighting.

9. The vehicle of claim 1, wherein the powered chassis includes a fuel powered electricity generator.

10. The vehicle of claim 1, wherein the automated flight control system includes a collision detection module.

11. An un-manned aerial vehicle, comprising:
a) a powered chassis having a top side and a bottom side;
b) a flight system functionally coupled to the powered chassis;
c) a flood light system functionally coupled to the powered chassis and oriented to project light downward therefrom; wherein the flood light system includes a plurality of modular lights able to selectably couple to the bottom side of the powered chassis; and
d) a flight control system functionally coupled to the flight system that directs light from the flood light system to a desired region.

12. The vehicle of claim 11, wherein the flood light system includes a plurality of modular lights able to selectably couple to the bottom side of the powered chassis.

13. The vehicle of claim 12, wherein the flight control system is automated and includes a tracking module that follows a mobile object.

14. The vehicle of claim 13, wherein the flight system is collapsible.

15. The vehicle of claim 14, further comprising a plurality of retractable legs functionally coupled to the powered chassis; wherein the plurality of retractable legs include modular light mounts.

16. The vehicle of claim 15, wherein the flood light system includes a programmable light control module that controls lighting.

17. The vehicle of claim 16, wherein the flight control system includes a swarm module that allows for singular control of a plurality of UAVs.

18. The vehicle of claim 17, wherein the powered chassis includes a fuel powered electricity generator.

19. The vehicle of claim 18, wherein the flight control system includes a collision detection module.

20. An un-manned aerial vehicle, comprising:
a) a powered chassis having a top side and a bottom side; wherein the powered chassis includes a fuel powered electricity generator;
b) a flight system functionally coupled to the powered chassis;
c) a flood light system functionally coupled to a bottom side of the powered chassis and oriented to project light downward therefrom; wherein the flood light system includes a plurality of modular lights able to selectably couple to the bottom side of the powered chassis; wherein the flood light system includes a plurality of modular lights able to selectably couple to the bottom side of the powered chassis; wherein the light system includes a programmable light control module that controls lighting;
d) a flight control system functionally coupled to the flight system that directs light from the flood light system to a desired region; wherein the flight control system is automated and includes a tracking module that follows a mobile object; wherein the flight control system includes a swarm module that allows for singular control of a plurality of UAVs; wherein the flight system is collapsible; wherein the flight control system includes a collision detection module; and
e) a plurality of retractable legs functionally coupled to the powered chassis; wherein the plurality of retractable legs include modular light mounts.
